(19) United States
(12) Patent Application Publication
(10) Pub. No.: US 2011/0014593 A1
(43) Pub. Date: Jan. 20, 2011

(54) (plus symbol over minus symbol) +- 1nt

(76) Inventor: Abhishek Kumar, East Meadow, NY (US)

Correspondence Address: Abhishek Kumar, 102 Bette Road, East Meadow, NY, 11554, US

(21) Appl. No.: 12/504,804

(22) Filed: Jul. 17, 2009

(51) Int. Cl. G09B 19/22; G09B 19/02

(52) U.S. Cl. 434/129; 434/188

(57) ABSTRACT

±1nt is an entertaining, multi-level card game involving the fundamentals of math. It is inclusive of four operands that are central to the game. The ±1nt also features a ±1nt scale reading and special cards. One of the unique features of this game is that it is an educational game and also a fun game. The various math applications provide the basic building blocks needed throughout life. It also helps build confidence for those that are not entirely comfortable with math applications. Additionally, the multi-level feature enables the game to be stimulating for people of all ages.

### CROSS-REFERENCE TO RELATED APPLICATIONS

N/A.

### STATEMENT REGARDING FEDERALLY SPONSORED RESEARCH OR DEVELOPMENT

N/A.

### REFERENCE TO SEQUENCE LISTING

N/A.

### BACKGROUND OF THE INVENTION

Math applications continue to exist in our everyday lives and it has become necessary for people to grasp a basic understanding of the topic. However there are individuals that struggle with math applications and the content of integers, essentially for academically. This invention, ±1nt, enables people to understand how to apply math when needed but also builds confidence in the process. Additionally this invention also allows students to excel in the subject.

### BRIEF SUMMARY OF THE INVENTION

This invention ±1nt, signifies the importance of Math and reminds us of why we need it to be integrated in our daily lives. ±1nt has several qualities, which comprise of fun, competitive learning and entertainment. The game also consists of different levels that involves interactive skills and allows every individual to have fun at every level. ±1nt prepares people for real-world applications. More importantly, we are able to learn how the math operations and positive/negative integers are applied by learning the use of operands. Playing the game is extremely fun for the family, friends and even among strangers while being a mentally stimulating challenge.

### BRIEF DESCRIPTION OF THE SEVERAL VIEWS OF THE DRAWING

FIG. 1: The front face of the card.

FIG. 2: The back face of the card.

FIG. 3: Sw1nt card.

FIG. 4: 0 card.

FIG. 5: ±1nt card.

FIG. 6: ±1nt Scale Reading card; instructs players what operand to use within the total domain.

FIG. 7: The back face of the card specifically with a divide operand.

FIG. 8: The back face of the card specifically with an add operand.

FIG. 9: The back face of the card specifically with a subtract operand.

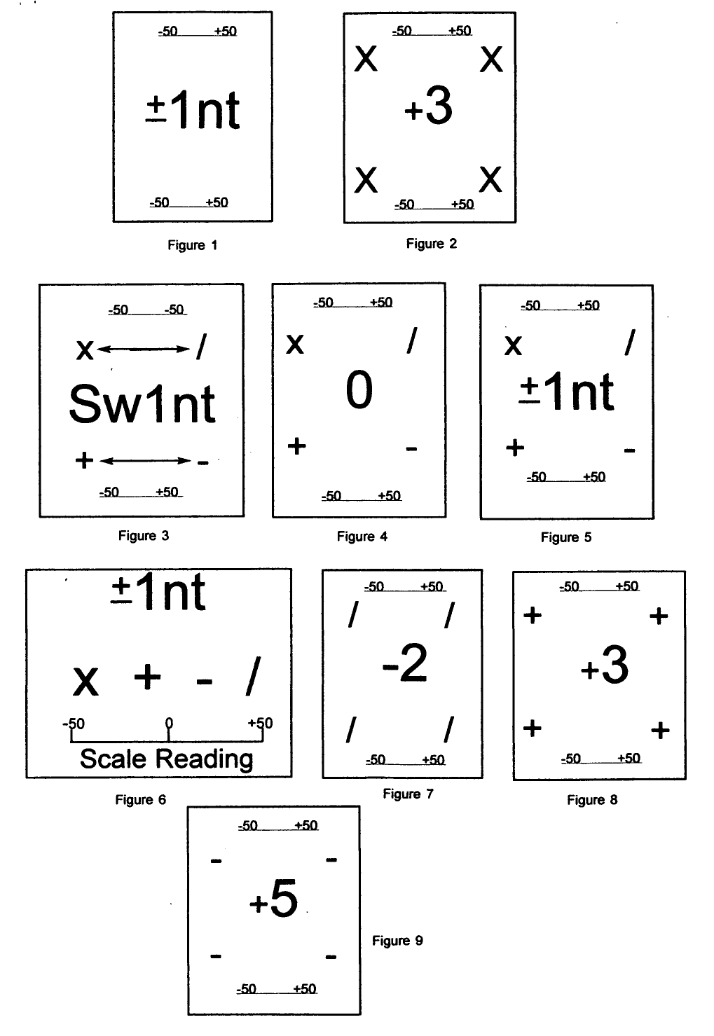

All figures are detailed below in the section labeled “Detailed Description of the Invention.”

### DETAILED DESCRIPTION OF THE INVENTION

Objective of ±1nt:

The math must be applied with respect to the card and to the player's best ability. The cumulative score must be an integer value and there should be neither decimals nor fractions and should not be outside of the ±1nt Scale Reading.

Further details about ±1nt Scale Reading is in the following pages. The following is an example of how the game is played with positive/negative signed total value. If the current total is +5 and the player throws a card labeled “+(−3)” and its sign is “+”, then the math applied would be +5+(−3)=+2. The current total is +2 and the next player goes. A player must finish the hand in order to win the game.

Tool: A Deck of Cards

Cards:

Number of cards in a deck: 96

Symbols Designed in the cards: “+” (Add); “−” (Subtract); “×” (Multiply); “/” (Divide).

Face Card Value: “+1,” “+2,” “+3,” “+4,” “+5,” “−1,” “−2,” “−3,” “−4,” “−5”—40 positive operands cards and 40 negative operands cards; 80 cards

Number of Special Cards: 12 cards

Name of Special Cards: “Sw1nt” Card—4 cards; “±1nt” Card—4 cards; “0” Card—4 cards. All features are in “Drawings” section.

±1nt Scale Reading: It has an absolute domain of −50 to +50 and the operands displays—4 cards. It is enclosed in the “Drawings” section.

Definitions of Special Cards:

“Sw1nt” Card: can turn the Addition sign “+” to a Subtraction sign “−” and vice versa. It can also turn the Multiplication sign “×” to a Division sign “/” and vice versa.

“±1nt” Card: This card is considered a bonus or wild card. A player can use this card by choosing any operand in the game regardless of the operand stated on a specific card. Specific operands are adding, subtracting, multiplying, and dividing.

The “±1nt” card can be used regardless of where the current total is. For an example: If the total is at +5 and the second player throws a card labeled “+(+3)” and its sign is “+”, then the math applied would be +5++3=+8. The current total is 8. Now it is the first player's turn and he chooses to use a “±1nt” card. The player uses a “±1nt” card with another card in his or her hand such as “+(+4),” but doesn't want to use the add operand. Fortunately with the “±1nt” card, the player can change the operand however the player chooses. The player changes the “+(+4),” to “×(+4)” which translates to +4×+8 and the current total is at +32 and the game continues.

Also, a player can use the “±1nt” card and change the second card to a division operand card only if the remainder of the function is strictly 0 or 1. A further detail is below in the Situations in “±1nt Game”; specifically situation #4)

“0” Card: This card is considered another bonus card. A player can choose whichever operands (adding, subtracting, multiplying, or dividing) to comply with the number 0. All features of the special cards are in the “Drawings” section.

±1nt Game:

Objective:

Math must be applied appropriately and the total must be an integer value between −50-+50. The total starts at 0 where it is considered a neutral point where the next player can decide to use any operand to either go above or less 0 total.

−50-+50 total:

The player must use, if the total is at:

0: Players may use either addition or subtraction operand or special card.

−50-+50: Players chooses any operand to play or special card.

The math must be played appropriately and must be within the scale reading.

The ±1nt Scale Reading is included in the “Drawings” section, FIG. 5.

Instruction of “±1nt’ Game:

There are 92 cards that are used (80 operand cards and 12 special cards). The starting total is 0. The first player can use any operand or special card. Special card can be used anytime in the game. The game optionally can have a pad to write down the total. During the game, if the deck is finished then shuffle the played cards to form a new deck and continue the game. Additionally, there is a ±1nt Scale Reading card to emphasize the utility of the cards played which is FIG. 5 on the “Drawings.”

Situations of “±1nt’ Game:

1. At the beginning of the game, the total is at 0. The first player can use any operand card to start or special card.

2. If a player does not have a card that is playable then the player must draw one card. If the card that is picked is playable then the player can play, otherwise draw another card and lose a turn.

3. If a player miscalculates during the game, then the player takes the card back, draws another card, and loses a turn. For an example, a player draws a “+(+5),” and its operand sign is add and the current total is at +3. This specific player says (+3)+(+5)=10, which is considered incorrect. The player takes the card back that was drawn which is the “+(+5)” card, draws another card from the deck and loses a turn. Also, the current total remains +3 and continues thereon.

4. If a player miscalculates total without using special card and going beyond the domain of −50 to +50, less than −50 or more than +50, then the player takes the drawn card back, draws another card, and loses a turn.

The only exception is the “±1nt” card which can surpass the total, either −50 or +50. Although the total can surpass −50 or +50 mathematically, the total must be stated as the minimum of −50 or the maximum of +50.

For an example:

Assuming the total is at +20, if a player throws a “±1nt” Card and chooses to use “×(+3)” card. The combination of the “±1nt” card will result over +50, (+20×(+3)=+60) mathematically. However, the current total will be at +50 specifically; vice versa for going beyond the total at −50.

The following is another scenario using “±1nt” card. The total is at −37 and a player chooses to use a “/(−4)” card. Mathematically, it would be incorrect but with the “±1nt” card you can use it since the result will be −37/−4=+9 remainder 1. Therefore, the total is at +9 disregarding the remainder.

5. If a player uses a card that results in a total of exactly 0, the next player must use any operand or special card.

6. If a player has a “0” card, then a player can choose to use whichever operand to comply with 0. For an example, the current total is at 55, and a player decides to use “0” Card using a division operand, the result total is 0; since 0/55=0.

±1nt Game (Advanced Level)

Objective:

Math must be played appropriately with its respect. The rules that are applied in respect to the total and the instructions are the same as above.

±1nt Game

There are no special cards included in this game; therefore there are only 80 operand cards to play with. This advanced game also has the same rules; however exceptional situations are detailed below. The major difference is that instead of focusing on the operands applied the players can manipulate any operand within the ±1nt Scale Reading total. In other words, you can use any operand that is appropriate to apply and must be within the integer domain value of −50 to +50.

−50-+50 total:

The player must use, if the total is at:

0: Players may use either addition or subtraction operand card.

−50-+50: Players chooses any operand card to play.

The math must be played appropriately and must be within the scale reading.

Instruction:

Each player is dealt an equal amount of cards until the deck is finished. If there is a remainder of cards they are used to start the game. There is only one alternative to start the game with the remainder cards, if available.

Take the card with the highest face value to start the game regardless of the operands. The resulting total is the highest face value, which is the card chosen.

For an example:

The remainder cards are “/(+5),” and “×(−3).” The game begins by choosing the +5 as the starting total.

Otherwise if there are equal amounts of cards distributed with no remaining cards available then the total is at 0; the first card must be use as an addition or subtraction operand card to start the game.

The participated players can choose to play predetermined amount of distributed cards with the deck and follow up the situation #4 and #5 indicated below. If the deck is empty, shuffle and continue thereon.

Situation:

1. If a player does not have a card to play with, then the player loses a turn.

2. If any math miscalculation occurs by the player, the player takes the card back that was played and loses a turn.

3. If no players can play on a specific round, then shuffle the cards that have been played and set it up as a deck. Follow up situations #4 and #5.

4. If any math miscalculation occurs, then the player takes the card back that was already played and loses a turn.

5. If the player does not have a card to play with, the player must pick a card from the deck and play it, if playable. Otherwise, draw another card and lose a turn.

What I claim as my invention is to the best of my knowledge, and true to the best of my ability. I have tried my invention to the best of my ability and have made the effort to implement, +1nt, a method for playing an educational game. My invention, +1nt, is comprised of:

1. A method of playing an educational game comprising the steps of:
(1) providing a deck of cards including a set of said playing cards having a display of a numerical value including an assigned arithmetic operation symbol designated and domain “−50 +50” designated, and a set of said playing cards having a display of an assigned special cards including of all four arithmetic operation symbols designated and domain “−50 +50” designated;
(2) dealing predetermined number of playing cards to a lity of players forming a hand for each players, forming said deck, and placing said deck facing down;
(3) providing and proceeding total;
(4) altering and recording said total;
(5) proceeding each player in turn which further comprises the steps of:
(a) choosing said card(s) from his/her said hand;
(b) calculating said card(s) from his/her said hand, placing said card(s) facing up, and altering and recording said total;
(c) drawing said card from the said deck; and
(d) proceeding to the next player with repetition steps from (5); and
(6) shuffling said playing cards when said deck is empty; and continue thereon until one player has no remaining cards from s his/her hand determines the winner; and the game may proceed for remaining players or start a new game.

2. The method of playing an educational game in accordance with claim 1, during the steps of (3) and (4), proceeding he game with said total at 0 wherein said total consists of integers exclusively between −50 and +50 during the play of the game, viewing said special card +1nt Scale Reading as a display of the range of “−50” to “+50” with assigned arithmetic operation symbols also graphically displayed to guide the said player staying in the domain of −50 to +50, and altering and recording said total as a new said total.

3. The method of playing an educational game in accordance with claim 1, during the step of (5)(a), a player choosing play any said playing card having a display of one numerical values from −5 to +5, without numerical value card of 0 including an assigned arithmetic operation symbol designated and domain “−50 +50” designated.

4. The method of playing an educational game in accordance with claim 3, a said playing card having one of arithmetic operation symbols designated are an addition (+) symbol, subtraction (−) symbol, multiplication symbol (×), and division (/) symbol.

5. The method of playing an educational game in accordance with claim 1 during the step of (5)(a), a player choosing to play a special card further comprising the steps of:
(1) if said special card is +1nt card, a player choosing any math operation in place of the arithmetic operation symbol designated on said playing cards having a display of a numerical value;
(2) if said special card is +1nt card, a player choosing a division math operation in place of the arithmetic operation symbol designated on said playing cards having a display of a numerical value then a player can only divide said total by a said playing card only with remainder 0 or 1 in which the quotient is altered and recorded as a new said total disregarding the remainder;
(3) if said special card is +1nt card, a player choosing any math operation in place of the arithmetic operation symbol designated on said p cards having a display of a numerical value used to surpass the said total at either −50 or +50 and the new said total must be stated as the minimum of −50 or the maximum of +50 by altering and recording this new said total;
(4) if said special card is Sw1nt card, a player choosing to turn addition operation symbol “+” to a subtraction operation symbol “−” designated on said playing cards having a display of a numerical value and vice versa;
(5) if said special card is Sw1nt card, a player choosing to turn multiplication operation symbol “×” to a division operation symbol “/” designated on said playing cards having a display of a numerical value and vice versa; and
(6) if said special card is 0 card, a player choosing any math operation in place of the arithmetic operation symbol designated on said special card complying with numerical value 0;

6. The method of playing an educational game in accordance with claim 1, during the step of (5)(b), where a player calculating said card(s) from his/her said hand, placing said cards(s) facing up, and altering and recording said total further comprising the steps of: (1) if said cumulative point is 0, said player choosing only one of said playing card(s) comprising addition operand card, subtraction operand card or said special card, and (2) if said total is in the domain inclusively between −50 and +50, said player choosing only one of said card(s) comprising addition operand card, subtraction operand card, multiplication operand card, division operand card, or said special card.

7. The method of playing an educational game in accordance with claim 1, during the step of (5)(b) where a player calculating said card(s) from his/her said hand, placing said cards(s) facing up, and altering and recording said total further comprising the steps of: (1) if said total is correct, said player altering and recording total as a new said total; and (2) if said total is wrong, said player not altering and recording the said total as a new said total.

8. The method of playing an educational game in accordance with claim 1, during the step of (5)(c) where a player drawing a card from the said deck further comprising the steps of: if said player cannot use his/her said hand, the said player drawing a said card from the said deck wherein (a) if said drawn card can be played then play the said drawn card, and (b) if said drawn card cannot be played then said player must draw another said card from the said deck and continue thereon to the next said player.

9. A method of playing an educational game comprising the steps of:
(1) providing a deck of cards including a set of said playing cards having a display of a numerical value including an assigned arithmetic operation symbol designated and domain “−50 +50” designated;
(2) dealing playing cards to a plurality of players forming a hand for each players wherein (a) if dealing evenly among said players and there is no said deck, (b) if dealing evenly among said players where remaining card(s) are available and there is no said deck, and (c) if dealing predetermined number of said card(s) among said players, forming said deck, and placing said deck facing down;
(3) determining and proceeding total;
(4) altering and recording said total;
(5) proceeding each player in turn which further comprises the steps of:
(a) choosing said card(s) from his/her said hand;
(b) calculating said card(s) from his/her said hand, placing said card(s) facing up, and altering and recording said total;
(c) drawing said card from the said deck; and
(d) proceeding to the next player with repetition steps from (5); and
(6) shuffling said playing cards where said deck is empty and/or there is no said deck, or when no said players can play his/her said hand; and continue thereon until one player has no remaining cards on his/her said hand determines the winner; and the game may proceed for remaining players or start a new game.

10. The method of playing an educational game in accordance with claim 9, further comprising the steps of: during the step of (2)(c), if there is no said deck then no drawing occurs wherein (a) if said player cannot play his/her said hand, then continue thereon to the next said player, and (b) if said player calculates wrong then said player takes ba ced said card, and the said total is not altered nor recorded as a new said total and continue thereon to the next said player.

11. The method of playing an educational game in accordance with claim 9, further comprising the steps of: during the steps of (2)(a),(2)(b), and (6), if there is no said deck and/or no said players playing his/her said hand further comprising the steps of: shuffling said playing cards, forming said deck, placing faced down said deck, and said player drawing a said card from the said deck wherein, (a) if said drawn card can be played then play the said drawn card, and (b) if said drawn card cannot be played then said player must draw another said card from the said deck and continue thereon to the next said player.

12. The method of playing an educational game in accordance with claim 9, during the steps of (2)-(4), determining and proceeding the game with said total further comprising the steps of: (a) if dealt equally to plurality of said players, proceeding the game with said cumulative point at 0, (b) if dealt equally to plurality of said players with remaining card(s) available, proceeding the game with said total at the highest said numerical value from said remaining card(s), and (c) if dealt predetermined number of said card(s) among said players and having said deck formed placing face down, proceeding the game with recording said cumulative point at 0.

13. The method of playing an educational game in accordance with claim 12, said total consists of integers exclusively between −50 and +50 during the play of the game, and viewing said special card ±1nt Scale Reading as a display of the range of “−50” to “+50” with assigned arithmetic operation symbols also graphically displayed to guide the said player staying in the domain of −50 to +50, and altering and recording said total as a new said total.

14. The method of playing an educational game in accordance with claim 9, during the step of (5)(a), a player choosing to play any said playing card having a display of one numerical values from −5 to +5 without numerical value of 0 including an assigned arithmetic operation symbol designated and domain “−50 +50” designated.

15. The method of playing an educational game in accordance with claim 14, a said playing card having one of arithmetic operation symbols designated are an addition (+) symbol, subtraction (−) symbol, multiplication symbol (×), and division (/) symbol.

16. The method of playing an educational game in accordance with claim 9, during the step of (5)(b), where a player calculating said card(s) from his/her hand, placing said cards facing up, and altering and recording said total further comprising the steps of: (1) if said cumulative point is 0, said player choosing only one of said playing card comprising addition operand card or subtraction operand card and (2) if said total is −50 and +50, said player choosing only one of said playing card comprising addition operand card, subtraction operand card, multiplication operand card, or division operand card.

17. The method of playing an educational game in accordance with claim 9, during the step of (5)(b), where a player calculating said card from his/her hand, placing said cards facing up, and altering and recording sa total further comprising the steps of: (1) if said total is correct, said player altering and recording total as a new said total; and (2) if said total is wrong, said player not altering and recording the said total as a new said total.
